(19) United States
(12) Patent Application Publication
(10) Pub. No.: US 2007/0268365 A1
(43) Pub. Date: Nov. 22, 2007

(54) Entrance surveillance system

(76) Inventor: Bin-Chang Lee, Miaoli County (TW)

Correspondence Address: PRO-TECHTOR INTERNATIONAL SERVICES, 20775 NORADA CT., SARATOGA, CA, 95070, US

(21) Appl. No.: 11/435,480

(22) Filed: May 16, 2006

(51) Int. Cl. H04N 7/18

(52) U.S. Cl. 348/143

(57) ABSTRACT

An entrance surveillance system comprises an image receiver, mounted on an outer side of a door wing, and a liquid crystal display (LCD), mounted on an inner side of the door wing, receiving image signals from the image receiver and displaying the image signals.

### BACKGROUND OF THE INVENTION

1. Field of the Invention

The present invention relates to an entrance surveillance system, particularly to an entrance surveillance system that allows for observation of an area in front of a door without opening the door or staying close to the door.

2. Description of Related Art

Residential places are provided with doors for entering and leaving while protecting intimacy. For surveying an area in front of a door, a spyhole in the door is often used, which is a divergent lens and conveniently allows to look outside from the inside, but not vice versa.

However, using a spyhole requires to place one eye close to the spyhole, which is hard for persons of small stature and handicapped persons.

### SUMMARY OF THE INVENTION

An object of the present invention is to provide an entrance surveillance system which allows to observe an area in front of a door from behind the door.

Another object of the present invention is to provide an entrance surveillance system which can be used from a distance.

A further object of the present invention is to provide an entrance surveillance system with recording and broadcasting functions.

A further object of the present invention is to provide an entrance surveillance system which co-operates with satellite information systems.

The present invention can be more fully understood by reference to the following description and accompanying drawings.

### DETAILED DESCRIPTION OF THE PREFERRED EMBODIMENTS

As shown in FIGS. 1 and 2, the entrance surveillance system of the present invention is mounted on a door wing 1 and comprises an image receiver 10, mounted on an outer side of the door wing 1, and a liquid crystal display (LCD) 20, mounted on an inner side of the door wing 1. From the image receiver 10, an image is transmitted to the LCD 20 and is visible there. Besides, the image is transmittable to an external device, e.g., a mobile phone or a computer, and thus visible from a far distance. The LCD 20 is further usable as an image recorder or as a broadcasting device. Below, more details are explained.

The image receiver 10 has a mini-camera mounted on a suitable place on the outer side of the door wing 1, for surveying a surveillance area in front of the outer side of the door wing 1.

The LCD 20 is thin and light and mounted on a suitable place on the inner side of the door wing 1. Image signals transmitted by the image receiver 10 are received and subsequently displayed by the LCD 20, allowing to view the surveillance area from the inner side of the door wing 1. The LCD 20 allows to display an image at any desired size, so that the surveillance area is clearly visible from afar.

The image receiver 10 and the LCD 20 are connected by cables, e.g, cables folowing the D-Sub15, RAC, S or F standards, or by a wireless connection.

As shown in FIG. 3, to minimize power consumption, the LCD 20 is provided with a control switch 21 for switching into a power saving mode. A full mode is activated by an infrared sensor, a door bell or manually.

A digital video recorder 22 and a security device 23 are connectible with the LCD 20, storing image sequences and providing security functions, furthermore transmitting image sequences to predetermined mobile phones and computers, so that a surveillance function from a distant place is enabled.

A communication device 24 allows for voice communication between the inner and outer sides of the door wing 1, without any need to open the door.

The LCD 20 is connected with a control computer 30 for storing data and allowing for further functions via the internet, for example:
1. displaying a previously recorded image, for aiding human memory;
2. broadcasting images;
3. displaying date, weather or traffic information.

The LCD 20 is combined with a face recognition device 40 to recognize a previous visitor, retrieve recorded data about the visitor and sound a greeting to the visitor.

Furthermore, the LCD 20 co-operates with a satellite information system 50, receiving current information therefrom and displaying current information.

As shown in FIG. 4, in a second embodiment of the present invention, the image receiver 10 is directly connected with the digital video recorder 22, the security device 23, the face recognition device 40 and the satellite information system 50.

As shown in FIG. 5, in a third embodiment of the present invention, the door wing 1 is composed of an inner door wing 2 and an outer door wing 3, and the image receiver 10 is mounted on an outer side of the outer door wing 3, and the liquid crystal display (LCD) 20, mounted on an inner side of the inner door wing 2.

Assembly of components of the present invention and signal transmission are known art and therefore not further explained.

As above explanation shows, an image sequence of the surveillance area is taken by the image receiver 10 and clearly displayed by the LCD 20. Thus the surveillance area is visible from inside and in addition observable from external devices. Furthermore, image sequences are stored and processed by the digital video recorder 22 and the security device 23. Information from the control computer 30 or the satellite information system 50 are displayed on the LCD 20.

### BRIEF DESCRIPTION OF THE DRAWINGS

FIG. 1 is a view of the entrance surveillance system of the present invention from inside.

FIG. 2 is a view of the entrance surveillance system of the present invention from outside.

FIG. 3 is a schematic diagram of the entrance surveillance system of the present invention.

FIG. 4 is a schematic diagram of the entrance surveillance system of the present invention in the second embodiment.

FIG. 5 is a perspective view of the entrance surveillance system of the present invention in the third embodiment.

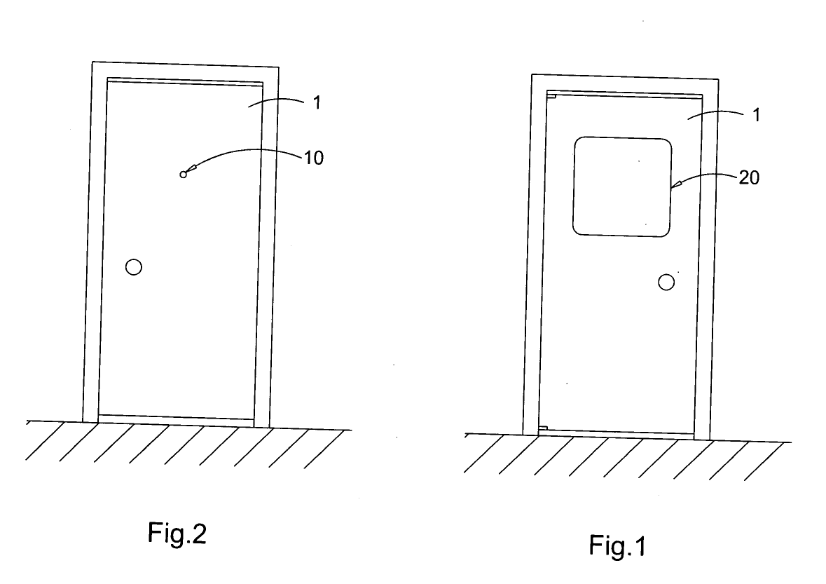

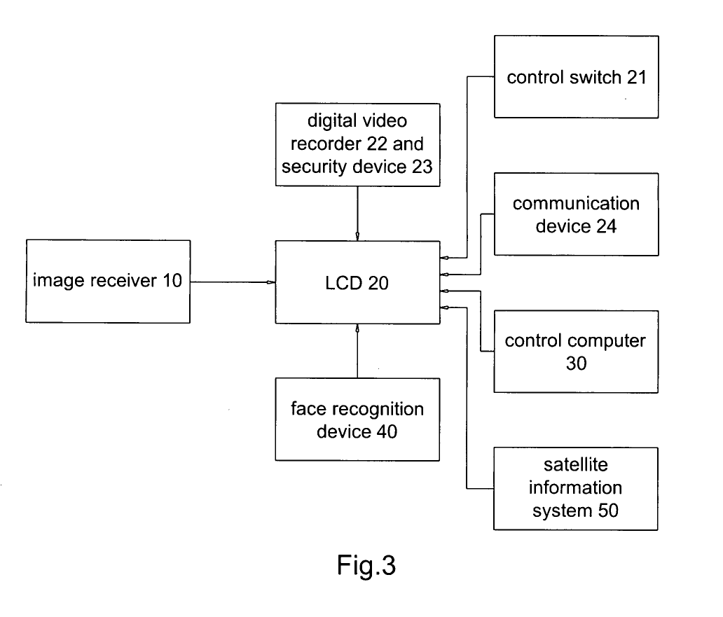

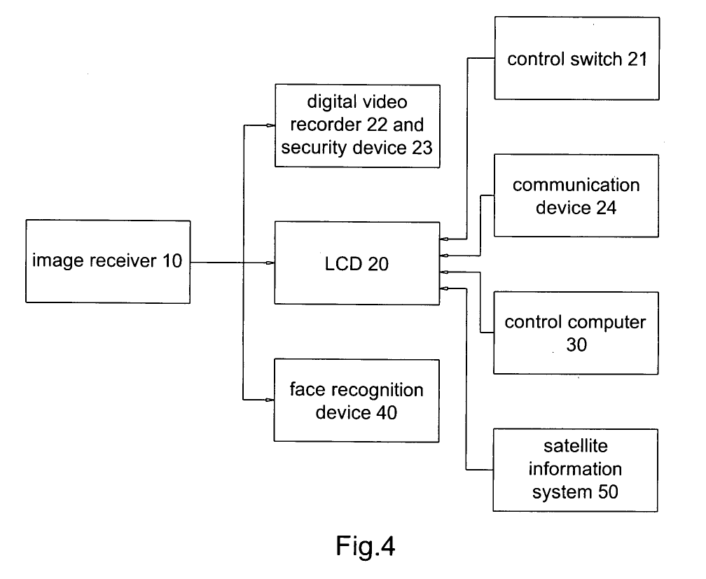

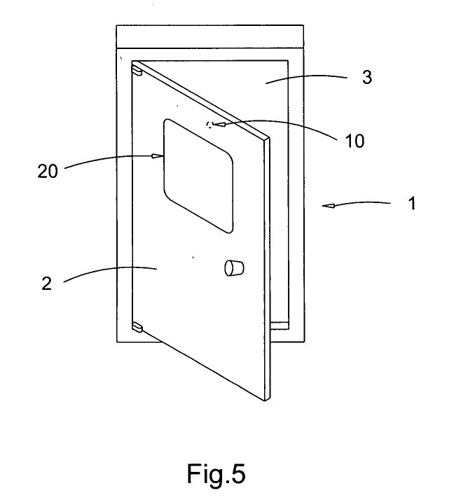

1. An entrance surveillance system, comprising
an image receiver, mounted on an outer side of a door wing; and
a liquid crystal display (LCD), mounted on an inner side of said door wing, receiving image signals from said image receiver and displaying said image signals.

2. The entrance surveillance system according to claim 1, wherein said image receiver is a mini-camera.

3. The entrance surveillance system according to claim 1, wherein said image receiver transmits said image signals via a cable or wirelessly.

4. The entrance surveillance system according to claim 1, wherein said LCD receives said image signals via a cable or wirelessly.

5. The entrance surveillance system according to claim 1, wherein said LCD has a control switch.

6. The entrance surveillance system according to claim 5, wherein said control switch is controlled by an infrared sensing device.

7. The entrance surveillance system according to claim 5, wherein said control switch is controlled by a door bell.

8. The entrance surveillance system according to claim 1, wherein said LCD is connected with a digital video recorder and a security device.

9. The entrance surveillance system according to claim 8, wherein said digital video recorder and said security device transmit signals to pre-determined mobile phones and computers.

10. The entrance surveillance system according to claim 1, wherein said LCD is connected with a communication device.

11. The entrance surveillance system according to claim 1, wherein said LCD is connected with a control computer.

12. The entrance surveillance system according to claim 11, wherein information obtained from said control computer is displayed on said LCD.

13. The entrance surveillance system according to claim 1, wherein said LCD is connected with a face recognition device.

14. The entrance surveillance system according to claim 1, wherein said LCD is connected with a satellite information system.

15. The entrance surveillance system according to claim 1, wherein said image receiver is mounted on an outer side of an outer door wing and said LCD is mounted on an inner side of an inner door wing.
